(19) United States
(12) Patent Application Publication
(10) Pub. No.: US 2008/0300008 A1
(43) Pub. Date: Dec. 4, 2008

(54) Dual mode mobile terminal and method for providing communication mode

(75) Inventor: Ji Eun Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/154,933

(22) Filed: May 28, 2008

(30) Foreign Application Priority Data
May 29, 2007 (KR) 2007-0051953

(51) Int. Cl. H04M 1/00

(52) U.S. Cl. 455/552.1; 455/558

(57) ABSTRACT

A dual mode (dual standby) mobile terminal and a method for providing communication mode configuration interface for a dual mode mobile terminal that is capable of facilitating mode switching manipulation is provided. A method for providing a communication mode configuration interface for a multi-mode mobile terminal having at least two identity card slots, the mobile terminal operating multi-standby mode for at least two different communication networks, includes detecting a manual mode selection command; and displaying a mode selection screen presenting available communication modes with at least one identity card detected within the identity card slots in response to the manual mode selection command.

### CROSS-REFERENCE TO RELATED APPLICATION(S) AND CLAIM OF PRIORITY

This application claims priority to an application entitled “DUAL MODE MOBILE TERMINAL AND METHOD FOR PROVIDING COMMUNICATION MODE” filed in the Korean Intellectual Property Office on May 29, 2007 and assigned Serial No. 2007-0051953, the contents of which are incorporated herein by reference.

### TECHNICAL FIELD OF THE INVENTION

The present invention relates to a mobile terminal and, in particular, to a dual mode (dual standby) mobile terminal and a method for providing communication mode configuration interface for a dual mode mobile terminal that is capable of facilitating mode switching manipulation.

### BACKGROUND OF THE INVENTION

Dual mode mobile terminal is a device that can operate on two different network standards.

Typically, a dual mode mobile terminal is provided with two subscriber identity module (SIM) card slots such that the operation modes of the mobile phone are determined by the inserted SIM cards.

In a case that a Code Division Multiple Access User Identity Module (CDMA UIM) is inserted into one slot while no SIM or UIM card is in the other slot, the dual mode mobile terminal is supposed to operate as a single mode mobile phone, i.e. the dedicated CDMA mobile phone.

In another case that a global system for mobile communications (GSM) subscriber identity module (SIM) and CDMA UIM cards are inserted into respective card slots of the dual mode mobile terminal, it can operate in one of CDMA and GSM modes or both, i.e. in dual standby mode.

However, such dual mode mobile terminal is limited in combination of operation modes due to the carriers' requirements and technical restrictions as well as types of cards. For example, any dual mode mobile terminal is so configured such that two identity cards of the same communication standard are not allowed to be attached simultaneously and the GSM mode cannot be selected as the main operation mode.

In the conventional dual mode mobile terminal, the operation mode is selected in an initial booting process or by user manually later. During the mode selection process, the mobile phone checks the identity cards inserted within the card slots and displays an identity card list on the screen such that the user can set a combination of the operation modes with main mode. Typically, when the combination of the operation modes is inappropriate, the mobile phone alerts the user to reset the combination of the operation modes.

For example, if the CDMA mode is designated for both the card slots, the mobile phone may output an alarm message notifying that an identical operation mode cannot be designated for two card slots.

However, such conventional mode selection procedure of a dual mode mobile terminal requires repeated reset manipulation for finding out an appropriate combination of operation modes, resulting in time consumption and user inconvenience.

### SUMMARY OF THE INVENTION

To address the above-discussed deficiencies of the prior art, it is a primary object of the present disclosure to provide a dual mode (dual standby) mobile terminal and a method for providing a communication mode configuration interface of a dual mode mobile terminal that is capable of facilitating mode configuration manipulation.

Also, the present invention provides a dual mode mobile terminal and a method for providing a communication mode configuration interface of a dual mode mobile terminal that is capable of presenting available combinations of communication modes supported by at least one currently attached identity card.

In accordance with an aspect of the present invention, a method for providing a communication mode configuration interface for a multi-mode mobile terminal having at least two identity card slots, the mobile terminal operating multi-standby mode for at least two different communication networks, includes detecting a manual mode selection command; displaying a mode selection screen presenting available communication modes with at least one identity card detected within the identity card slots in response to the manual mode selection command.

In accordance with another aspect of the present invention, a multi-mode mobile terminal includes at least two identity card slots for receiving identity cards, respectively; a first communication unit for operating the mobile terminal in a first communication mode; a second communication unit for operating the mobile terminal in a second communication mode; a input unit for receiving user commands; a display unit for providing a communication mode configuration interface screen; a storage unit for storing information on available identity cards and available combinations of communication modes; and a control unit for generating available combinations of the communication modes supported by at least one identity card inserted within at least one of the identity card slots and displaying the available combinations on the communication mode configuration interface screen of the display unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a dual mode mobile terminal according to an exemplary embodiment of the present invention;

FIG. 2 is a diagram illustrating steps of a communication mode selection procedure of the dual mode mobile terminal according to an exemplary embodiment of the present invention;

FIG. 3 is a diagram illustrating steps of a communication mode selection procedure of a dual mode mobile terminal according to another exemplary embodiment of the present invention;

FIG. 4 is a diagram illustrating steps of a communication mode selection procedure of a dual mode mobile terminal according to an exemplary embodiment of the present invention; and

FIG. 5 is a flowchart illustrating a communication mode configuration method according to an exemplary embodiment of the present invention.

### DETAILED DESCRIPTION OF THE INVENTION

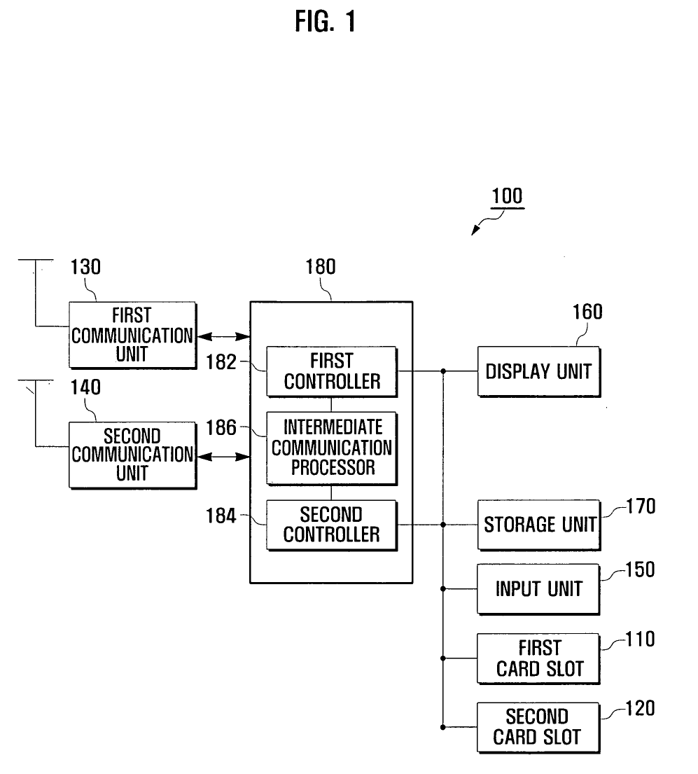

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 is a block diagram illustrating a dual mode mobile terminal according to an exemplary embodiment of the present invention.

In FIG. 1, the dual mode mobile terminal 100 includes two card slots 110 and 120, a first communication unit 130 to operate the mobile terminal in a first communication mode, a second communication unit 140 to operate the mobile terminal in a second communication mode, an input unit 150 to receive user commands, a display unit 160 to provide a communication mode configuration interface screen, a storage unit 170 to store information on available identify cards and available combination of communication modes, and a control unit 180.

Each of the first and second card slots 110 and 120 can receive an identity card (SIM or UIM) such as CDMA, GSM, Wireless Broadband (WiBro), high speed downlink packet access (HSDPA) cards.

A main communication mode of the mobile terminal is determined by the identity card inserted into the first card slot 110 such that the mobile terminal 100 can operate in the CDMA, GSM, WiBro, or HSDPA mode. A secondary communication mode of the mobile terminal can be one of the rest communication modes except for the main communication mode. That is, one communication mode cannot be designated for the first and secondary communication units 130 and 140 simultaneously.

The control unit 180 includes a first controller 182 for controlling the first communication unit 130, a second controller 184 for controlling the second communication unit 140, and an intermediate communication processor 186 for processing intercommunication between the first and second controller 182 and 184.

One of the first and second control controllers 182 and 186 can be designated as a primary controller for controlling cooperation of the internal units and the other as a secondary controller for controlling the operation associated with the secondary operation mode. The roles of the primary and secondary controllers 182 and 184 can be interchanged according to the circumstance.

When the a manual mode selection option is activated, the control unit 180 controls the display unit 160 to display an available mode combination list formatted in accordance with the identity cards seated within the first and second card slots 110 and 120 on its screen so as to prevent the user to select an unavailable mode combination.

The manual mode selection option allows the user to select a mode combination from the available communication mode combination list provided by the mobile terminal.

The control unit 180 can restrict the secondary communication mode of the mobile terminal 100 depending on the first communication mode. Ruling out the incompatible communication modes prevents the user from selecting unavailable secondary communication mode.

In a case that an automatic mode selection option is enabled, the control unit 180 configures a preferred communication mode pairs on the basis of the identity card inserted into one of the first and second card slots 110 and 120. That is, if an identity card is inserted into one of the first and second card slots 110 and 120, the control unit 180 determines another communication mode available with the other card slot and displays the selected communication mode on the screen of the display unit 160.

Table 1 shows available communication mode combinations for a dual mode mobile terminal. Table 1 informs of compatibilities of identity cards and communication modes.

TABLE 1

| | SLOT 1 | | SLOT 2 | | |
|---|---|---|---|---|---|
| Index | CARD | MODE | CARD | MODE | Availability |
| 1 | CDMA | CDMA | Empty | — | Available |
| 2 | CDMA | CDMA | GSM | Not | Available |
| | | | | Selected | |
| 3 | CDMA | CDMA | GSM | GSM | Available |
| 4 | CDMA | CDMA | CDMA | Not | Available |
| | | | | Selected | |
| 5 | CDMA | CDMA | CDMA | CDMA | Unavailable |
| 6 | CDMA | CDMA | Dual | Not | Available |
| | | | | Selected | |
| 7 | CDMA | CDMA | Dual | GSM | Available |
| 8 | CDMA | CDMA | Dual | CDMA | Unavailable |
| 9 | Dual | CDMA | Empty | — | Available |
| 10 | Dual | CDMA | GSM | Not | Available |
| | | | | Selected | |
| 11 | Dual | CDMA | GSM | GSM | Available |
| 12 | Dual | CDMA | CDMA | Not | Available |
| | | | | Selected | |
| 13 | Dual | CDMA | CDMA | CDMA | Unavailable |
| 14 | Dual | CDMA | Dual | Not | Available |
| | | | | Selected | |
| 15 | Dual | CDMA | Dual | GSM | Available |
| 16 | Dual | CDMA | Dual | CDMA | Unavailable |
| 17 | GSM | * | * | * | Unavailable |
| 18 | Dual | GSM | Empty | — | Available |
| 19 | Dual | GSM | GSM | Not | Available |
| | | | | Selected | |
| 20 | Dual | GSM | GSM | GSM | Unavailable |
| 21 | Dual | GSM | CDMA | Not | Available |
| | | | | Selected | |
| 22 | Dual | GSM | CDMA | CDMA | Available |
| 23 | Dual | GSM | Dual | Not | Available |
| | | | | Selected | |
| 24 | Dual | GSM | Dual | GSM | Unavailable |
| 25 | Dual | GSM | Dual | CDMA | Available |
| 26 | Empty | — | GSM | CSM | Available |
| 27 | Empty | — | CDMA | CDMA | Available |
| 28 | Empty | — | Dual | GSM | Available |
| 29 | Empty | — | Dual | CDMA | Available |
| 30 | Empty | — | Empty | — | Unavailable |

In Table 1, the GSM SIM card is unavailable for the first identity card slot 110 as indicated by index 17, and the two identity cards of the same communication standard are unavailable for simultaneous usage within two card slots as indicated by index 5, 8, 13, 16, 20, 24.

Although the CDMA UIM and GSM SIM cards are compatible in Table 1, the present invention is not limited thereto. For example, the dual mode mobile terminal of the present invention can be configured such that the CDMA UIM card can be compatibly activated with a WiBro card but not with the GSM SIM card according to the policies of the carriers and standard organizations.

In a case that two dual standard identity cards are inserted into the first and second card slots 110 and 120 respectively, the communication modes of the mobile terminal can be configured as in indexes 14 to 16 and 23 to 25. In this case, the control unit 180 displays a mode configuration screen by means of the display unit 160 in order for the user to select the communication modes for respective identity cards.

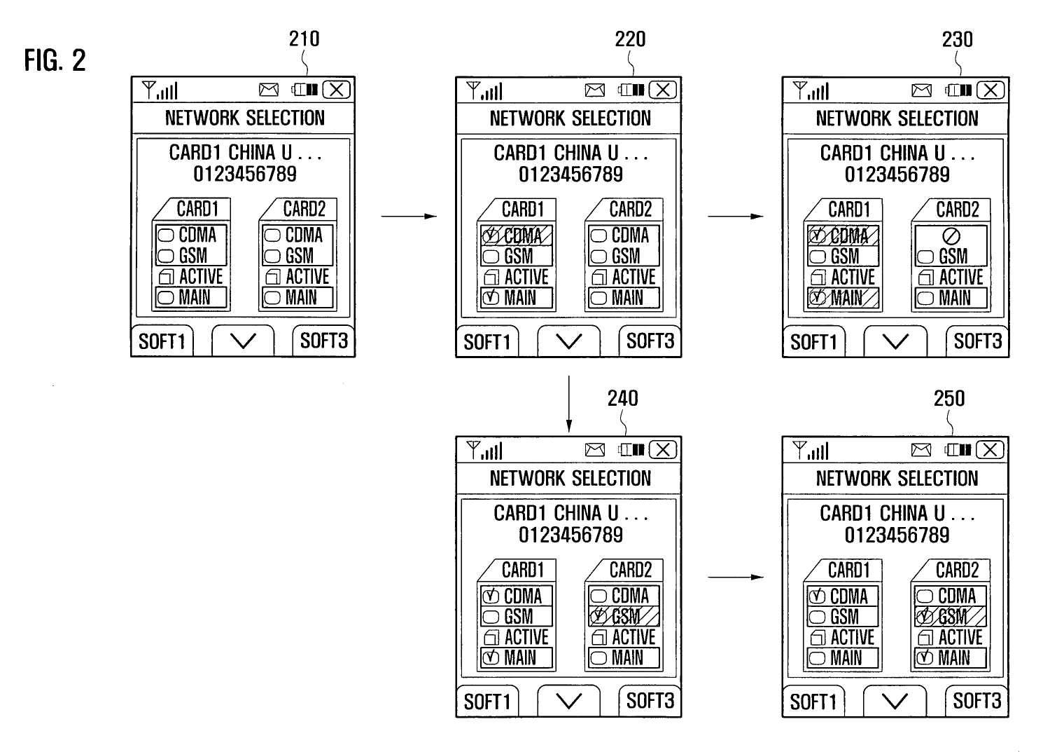

FIG. 2 is a diagram illustrating steps of a communication mode selection procedure of the dual mode mobile terminal according to an exemplary embodiment of the present invention.

Referring to FIG. 2, a mode configuration screen presents available modes of the respective identity cards inserted within the first and second card slots 110 and 120. The screen image 210 shows that both the identity cards inserted into the first and second card slots 110 and 120 are CDMA-GSM dual standard identity cards.

The user can select a CDMA mode for the identity card of the first card slot 110 and designate the CDMA mode as the main communication mode as shown in the screen image 220. If the CDMA mode of the dual standard identity card inserted into the first card slot 110 as indicated by the indexes 14 to 16 in Table 1, the CDMA mode is unavailable with the identity card of the second card slot 120. Accordingly, the control unit 180 disables the CDMA option of the identity card inserted into the second card slot 120 as shown in the screen image 230.

Also, the control can automatically select the GSM mode of the identity card of the second card slot 120 as shown in the screen image 240 (see index 15 in Table 1).

While the screen image 240 is displayed on the screen, the user can change the main communication mode by checking the “main” option of the identity card inserted into the second card slot 120 as shown in the screen image 250. In this case the “main” option of the identity card of the first card slot 120 is automatically unchecked.

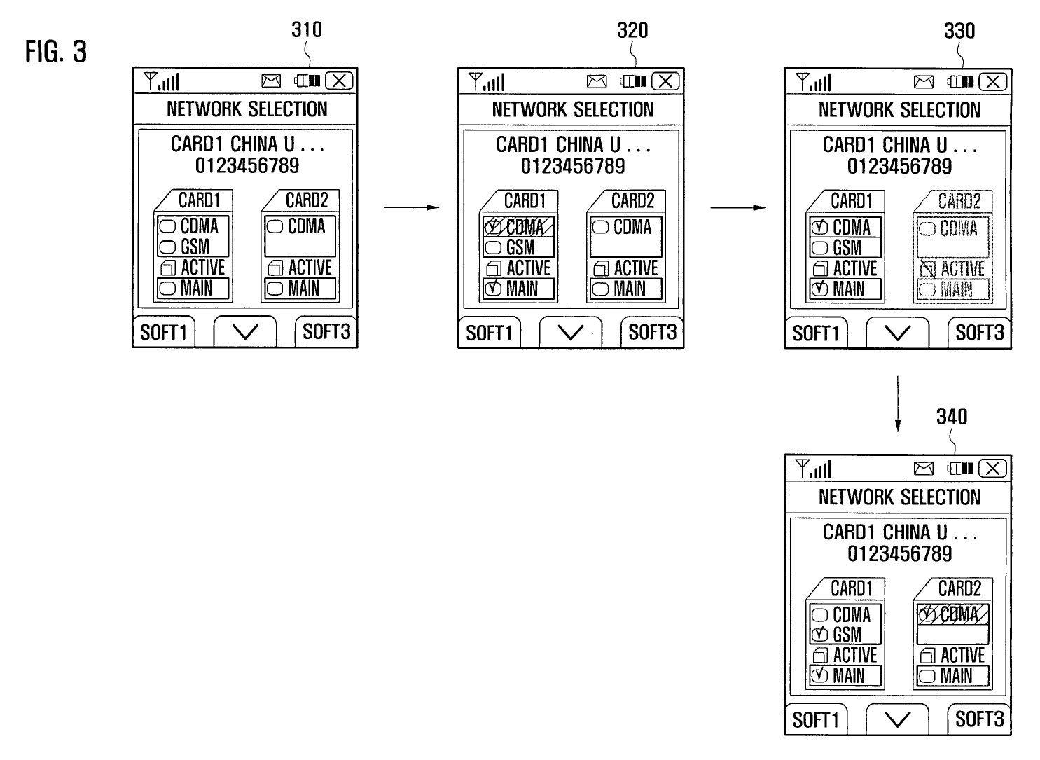

FIG. 3 is a diagram illustrating steps of a communication mode selection procedure of a dual mode mobile terminal according to another exemplary embodiment of the present invention.

Referring to FIG. 3, a dual standard identity card is inserted into the first card slot 110, and a CDMA UIM card is inserted into the second card slot 120 as shown in screen image 310 (see indexes 12, 13, 21, and 22 in Table 1).

In this case, the control unit 180 displays a mode configuration screen 310. The screen image 310 presents available communication modes supported by the identity cards inserted within the first and second card slots 110 and 120 together with respective check boxes such that the user can selects one of the CDMA and GSM modes of the first identity card by checking its check box and CDMA mode of the second identity card as shown in the screen image 320.

If the CDMA mode is selected for the first identity card, the CDMA mode of the second identity card cannot be selected according to the constraints of Table 1 (see indexes 12 and 13), whereby the control unit 180 deactivates the CDMA mode option of the second identity card as shown in the screen image 330. If a check box of the GSM mode of the first identity card is checked by the user while the screen image 330 is presented, the check box of the CDMA mode is unchecked and the CDMA mode of the second identity card is activated such that the user can configure the GSM mode for the first identity card as the main communication mode and the CDMA mode for the second identity card as shown in the screen image 340 (see index 22 in Table 1).

If a user command for requesting information on available communication mode combination is input, the control unit 180 checks the types of the identity cards inserted within the first and second card slots 110 and 120 and presents the communication modes and mode combinations available with the current identity cards on the screen of the display unit 160.

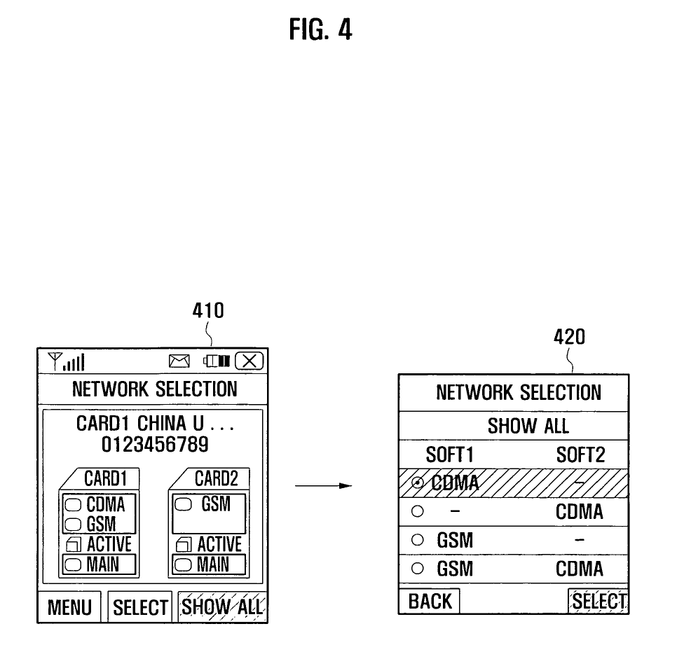

FIG. 4 is a diagram illustrating steps of a communication mode selection procedure of a dual mode mobile terminal according to an exemplary embodiment of the present invention.

If the first identity card inserted within the first card slot 110 is a dual standard identity card and the second identity card is a dedicated GSM SIM card (refer to indexes 10, 11, 19, and 20 in Table 1), the control unit 180 displays the mode configuration screen formatted as in the screen image 410 of FIG. 4 in which the CDMA and GSM options of the first identity card and the CDMA. If a “show all” command is input while the mode configuration screen is displayed, the control unit 180 presents the available communication mode and mode combinations with the first and second identity cards in the form of a communication mode list as shown in the screen image 420. Accordingly, the user can configure at least one communication mode of the mobile terminal 100 by selecting an item from the communication mode list. In a case that the communication mode list is too long to present on the screen, the screen is provided with a scroll bar such that the user can navigate all available communication modes.

Although not shown in drawings, the dual mode mobile terminal 100 can be provided with at least one of a camera module, a broadcast receiver module, an audio output module such as speaker, an audio input module such as microphone, a data port for exchanging data with exterior device, a charger port, and a multimedia player module such as MP3 player.

Although not all kinds of function modules that can be converged with the mobile terminal are listed, it is obvious to those skilled in the art that the dual mode mobile terminal can integrate various function modules and their equivalents.

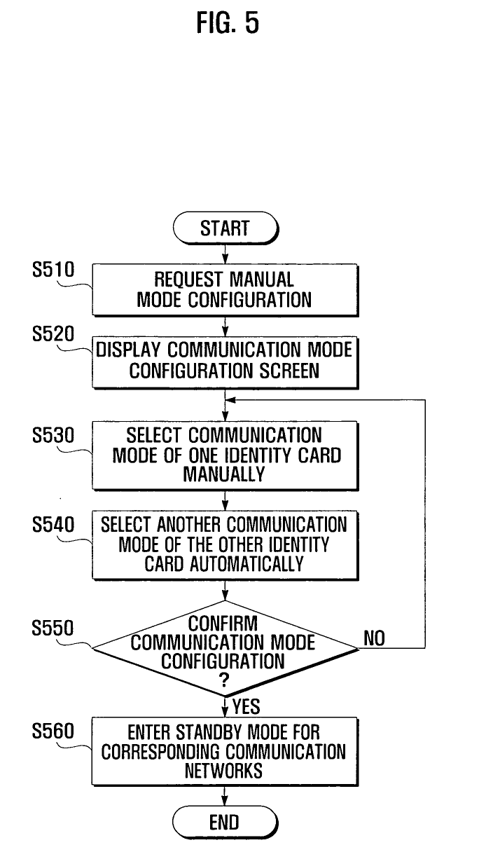

FIG. 5 is a flowchart illustrating a communication mode configuration method according to an exemplary embodiment of the present invention.

Referring to FIG. 5, if a manual mode configuration command is detected (S510), the control unit 180 of the dual mode mobile terminal 100 displays a communication mode configuration screen by means of the display unit 160 (S520). The communication mode configuration mode screen is provided with communication modes available with identity cards inserted within the first and second card slots 110 and 120.

For example, if two dual standard identity cards are detected within the respective first and second card slots 110 and 120, the control unit 180 controls to display the mode configuration screen formatted as the screen image 210 of FIG. 2, whereas, if a dual standard identity card and a CDMA UIM card are detected within the respective first and second card slots 110 and 120, the control unit 180 controls the display of the mode configuration screen formatted as the screen image 310 of FIG. 3. At this time, if a user command for requesting to show all available communication mode combinations is detected, the control unit 180 composes an available communication mode combination list on the basis of the communication modes supported by the identity cards inserted within the first and second card slots 110 and 120 and presents the available communication mode combination list by means of the display unit 160.

Next, the control unit 180 detects a mode command for selecting a specific communication mode of one of the two identity cards inserted within the first and second card slots 110 and 120 (S530). If the mode selection command is detected, the control unit 180 configures the mobile terminal 100 with the selected communication mode and activates the communication mode of the identity card of the second card slot 120 that is compatible with the previously selected communication mode (S540).

In the case that dual standard identity cards are detected within both the card slots 110 and 120 and the CDMA mode of the first identity card is selected as shown in the screen image 220 of FIG. 2, the control unit 180 composes a screen image 230 of FIG. 2 in which the first identity card is set as the main card and the CDMA mode of the second card is deactivated.

In the case that a dual standard identity card and a CDMA UIM card are detected within the respective first and second card slot 110 and 120 (see screen image 310 of FIG. 3) and CDMA mode of the dual standard identity card is selected as shown in the screen image 320 of FIG. 3, the control unit 180 sets the dual standard identity card as the main card and deactivates the CDMA mode of the CDMA UIM card as shown in the screen image 330 of FIG. 3.

Next, the control unit 180 determines whether a user command for confirming the communication mode configuration is input (S550). If a user confirmation command is detected, the control unit 180 configures the mobile terminal 100 with the communication modes such that the mobile terminal enters the standby mode for the corresponding communication networks (S560). Preferably, the mobile terminal 100 operates in a dual standby mode so as to communicate with two different networks.

If a rejection command is detected at step S550, the control unit 180 repeats steps S530 to S550 in order for the user to select another communication mode combination.

As described above, the dual mode mobile terminal and communication mode configuration method thereof according to the present invention provide a user with a communication mode configuration screen listing available communication mode combinations obtained in consideration of the compatibilities of the communication modes supported by two identity cards, thereby facilitating configuration of the dual communication modes by selecting a mode combination item on the mode configuration screen.

Also, the dual mode mobile terminal and communication mode configuration method thereof according to the present invention is advantageous in user convenience since the second communication mode is automatically selected by the mobile terminal in consideration of the compatibility with the first communication mode selected by the user.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing a communication mode of a multi-mode mobile terminal having at least two identity card slots, comprising:
detecting a manual mode selection command; and
displaying a mode selection screen presenting available communication modes with at least one identity card detected within the identity card slots in response to the manual mode selection command.

2. The method of claim 1, wherein the available communication modes are determined on a basis of a type of the at least one identity card, if two identity cards are inserted within the two identity card slots, and on compatibilities of communications modes embedded in the identity cards.

3. The method of claim 1, wherein displaying a mode selection screen comprises:
determining whether one of the communication modes of the at least one identity card is selected as a first communication mode manually; and
selecting one of the communication modes that is different from the first communication mode as a second communication mode automatically.

4. The method of claim 1, further comprising displaying, if an available mode combination request command is detected, all available combinations of the communication modes embedded in the at least one identity card, each combination having at least one combination mode.

5. The method of claim 4, wherein the available combinations comprises available communication modes combinations or available network operators combinations.

6. The method of claim 5, wherein each available mode combination comprises at least two among a code division multiple access (CDMA) mode, a global system for mobile communications (GSM) mode, a wireless broadband (WiBro) mode, and a high speed downlink packet access (HSDPA) mode.

7. A multi-mode mobile terminal comprising:
at least two identity card slots for receiving identity cards, respectively;
a first communication unit for operating the mobile terminal in a first communication mode;
a second communication unit for operating the mobile terminal in a second communication mode;
a input unit for receiving user commands;
a display unit for providing a communication mode configuration interface screen;
a storage unit for storing information on available identity cards and available combinations of communication modes; and
a control unit for generating available combinations of the communication modes supported by at least one identity card inserted within at least one of the identity card slots and displaying the available combinations on the communication mode configuration interface screen of the display unit.

8. The multi-mode mobile terminal of claim 7, wherein each of the identity card slots can receive an identity card supporting at least one of a code division multiple access (CDMA) mode, a global system for mobile communications (GSM) mode, a wireless broadband (WiBro) mode, and a high speed downlink packet access (HSDPA) mode.

9. The multi-mode mobile terminal of claim 7, wherein the first communication mode is one of a code division multiple access (CDMA) mode, a global system for mobile communications (GSM) mode, a wireless broadband (WiBro) mode, and a high speed downlink packet access (HSDPA) mode.

10. The multi-mode mobile terminal of claim 7, wherein the second communication mode is one of a code division multiple access (CDMA) mode, a global system for mobile communications (GSM) mode, a wireless broadband (WiBro) mode, and a high speed downlink packet access (HSDPA) mode.

11. The multi-mode mobile terminal of claim 7, wherein the control unit is configured to deactivate communication modes of one identity card that are incompatible with the communication mode activated with the other identity card.

12. The multi-mode mobile terminal of claim 7, wherein the control unit is configured to select the second communication mode automatically according to the first communication mode selected manually.

13. The multi-mode mobile terminal of claim 7, wherein the control unit is configured to generate a list having all available combinations of communication modes supported by at least one identity card inserted within at least one of the identity card slots.

14. The multi-mode mobile terminal of claim 8, wherein the identity card contains information on at least one available network operator mode.
